(19) United States
(12) Patent Application Publication
(10) Pub. No.: US 2010/0058996 A1
(43) Pub. Date: Mar. 11, 2010

(54) Tether for use with autistic children

(76) Inventor: Eric J. Hamblen, Beaverton, OR (US)

Correspondence Address: James D. Givnan, Jr., 8175 S. W. Ernst Road, Portland, OR, 97225, US

(21) Appl. No.: 12/283,117

(22) Filed: Sep. 10, 2008

(51) Int. Cl. A62B 35/00

(52) U.S. Cl. 119/770

(57) ABSTRACT

A tether for use with autistic children includes belts, one each for wear by an adult and a child for maintaining them side by side during a training session. Tether attached rings are confined by fabric closure members on the belts to maintain proximity of child and adult but can yield upon increased tensioning of the tether. The tether has spaced loops for adjusting tether length. A lock is provided to secure a tether end.

### BACKGROUND OF THE INVENTION

The present invention pertains generally to a device for assisting disabled children diagnosed as being autistic.

Such children are introverted to the extreme and may be helped by persons trained in promoting conversation with the child.

It has been determined that such interchanges can be fostered by mutual casual conversations about random objects viewed during a walk in an area of interest such as a park, garden, zoo, etc. Such conversations are promoted by the proximity of the adult and the autistic person and hindered by the separation of same.

U.S. Pat. No. 6,675,742 shows a leash with a series of grommets selectively receiving end mounted snaps to vary the effective length of the leash.

U.S. Pat. No. 4,667,624 discloses a harness to join an adult and child with an adjustable strap. Both have a waistband with snap hooks for attachment to the adult's waistband and to a harness on the child.

### BRIEF SUMMARY OF THE INVENTION

The invention is disclosed as including a tether between at least two persons. The tether is provided with a release feature permitting the autistic person to experience separation loss of association and hence loss of a conversation with the adult. Reestablishment of the tether connection appears to have a positive effect on the desire to communicate or resume the earlier side by side relationship.

The term child is used presently to identify a person experiencing autism, usually a person of pre-adult age.

A release feature of the tether is responsive to tensioning with tether separation occurring, after opening of a fabric closure component. The gradual displacement of a tether a tether attached ring provides an audible indication, to the child, of impending detachment from the adult. A secondary release provides increased, retention of a tether D-ring when required.

### BRIEF DESCRIPTION OF THE DRAWING

In the drawing:

FIG. 1 is a view of the tether in use,

FIG. 2 is a fragmentary plan view of the tether;

FIG. 3 is a fragmentary plan as a modified tether;

FIG. 4 is an elevational view of a retainer on a belt fragment;

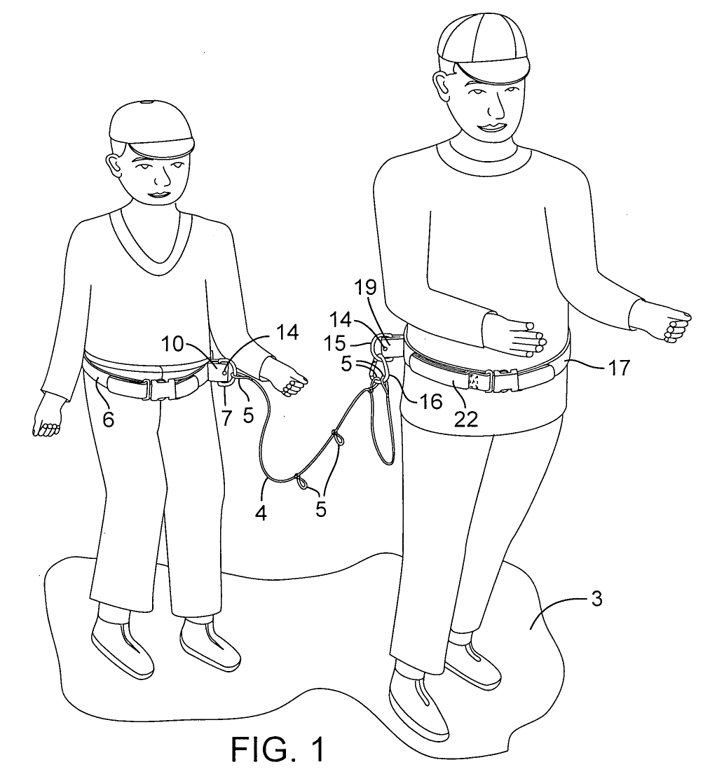

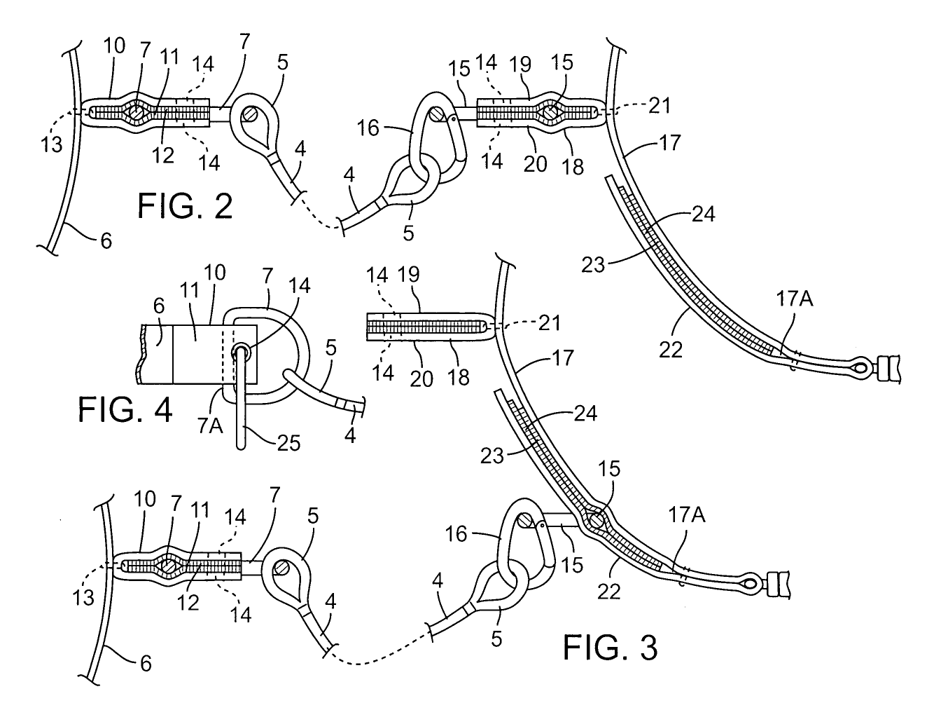

### DETAILED DESCRIPTION OF THE INVENTION

With continuing reference to the drawing wherein reference numerals identify parts hereafter similarly identified, numerals 1 and 2 indicate respectively an adult, preferably knowledgeable about autism, and an autistic person.

An area at 3 could be a park, yard, trail, etc., having objects of interest about which both parties would likely comment upon or discuss.

A tether at 4 is a cord a few feet in length preferably provided with spaced loops 5 for varying tether length.

The autistic person at 2 is provided with a belt 6 to receive one end of the tether by means of a ring 7, which may be a D-ring. A retainer 10 for the tether ring includes a fabric closure with hook and loop components 11 and 12 suitably affixed to belt 6 as by stitching 13. Ring 7 has a segment 7A in FIG. 4 extending beyond the upright width of the components 11 and 12, and is retained against movement by the action of the joined hook and loop components. Suitable closure material is marketed under the trademark VELCRO by the 3M Corporation.

If desired a lock may be provided to prevent separation of ring 7 from retainer 10. Grommets at 14 in each component 11 and 12 are in alignment to receive the lock such as a carabiner 25.

The travel of ring 7 between retainer components and toward separation is in response to tensioning of tether 4, which is audible and indicates to the child that separation with the adult may occur. Assuming the relationship is favorable, the child will likely attempt to prevent separation and retain the side by side relationship.

Tether 4 terminates at its remaining end in attachment to a ring 15, as by a carabiner 16, to the adult's belt at 17. A retainer 18 includes hook and loop components at 19 and 20 stitched at 21 to belt 17.

In use, the belts are applied to the parties with the rings disposed toward one another with the tether being inconspicuous. The adult will initiate a conversation based on observations made during their walk. The foregoing is a very brief description of the tethers use with but one technique provided as an example.

A secondary or optional retainer at 22 includes fabric closure components 23 and 24 respectively on adult belt segments 17-17A. Ring 15, in response to periodic tensioning of tether 4, must travel the length of closure components 23 and 24 for release.

While I have shown but a few embodiments of the tether, it will be apparent to those skilled in the art that the invention may be embodied still otherwise without departing from the spirit and scope of the claimed invention.

Having thus described the invention, what is desired to be secured by a Letters Patent is:

I claim:

1. A remedial teaching device for an autistic child and an adult and including,
first and second belts for wear on the torso of an adult and torso of a child,
a tether attached at its ends to said belts, and
a tether retainer on at least one of said belts serving upon tensioning of the tether to release said one said end of the tether upon divergent movement of the child and adult.

2. The tether claimed in 1 wherein said retainer includes a fabric closure.

3. A device for treating an autistic child by promoting conversation between the child and an adult, said device including,
a first belt for wear by an adult,
a second belt for wear by a child,
a tether between the belts to retain the child in proximity of the adult,
a retainer attaching one end of the tether to one of said belts and including fabric closure members and,
an opener element normally engaged with said closure members and responsive to tensioning of the tether permitting separation of the child and adult.

4. A tether device for temporarily joining an adult and a disabled child and including,
a tether,
a belt,
a D-ring affixed to one end of the tether,
a fabric closure members on said belt and closed about the D-ring to retain the D-ring against all but intentionally imparted forces.

5. A device for keeping two persons proximate and including,
first and second belts for wear respectively by two persons,
a tether, and
retainers attaching said tether to the first and second belts and at least one retainer including a fabric closure.

6. The device claimed in claim 5 wherein said tether includes a ring at a tether end.
